(19) United States
(12) Patent Application Publication
(10) Pub. No.: US 2005/0185770 A1
(43) Pub. Date: Aug. 25, 2005

(54) Voice interface board for providing operator services

(76) Inventors: Noel Hughes, Orange, CA (US); Steven J. Vialardi, Middlesex (GB)

Correspondence Address: JENKENS & GILCHRIST, PC, 1445 ROSS AVENUE, SUITE 3200, DALLAS, TX, 75202, US

(21) Appl. No.: 11/046,137

(22) Filed: Jan. 28, 2005

Related U.S. Application Data
(60) Provisional application No. 60/540,281, filed on Jan. 29, 2004.

(51) Int. Cl. H04M 1/64

(52) U.S. Cl. 379/67.1; 379/387.01

(57) ABSTRACT

An operator workstation for use by an operator to service subscriber calls, the operator workstation includes a processor, a voice interface circuit, an audio control circuit, and a network interface. The processor is for controlling the operator workstation and decoding and encoding digital data received from the network interface. The voice interface circuit includes a headset interface for transmitting received signals to at least one operator headset and for receiving signals from the at least one operator headset. The audio control circuit is coupled to the voice interface circuit and the processor and is for performing signal mixing for inputs and outputs derived from the voice interface circuit and decoded digital data generated by the processor. The network interface is coupled to the processor and is for transmitting and receiving digital signals with a media gateway. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims.

### CROSS-REFERENCE TO RELATED APPLICATIONS

This patent application claims priority from, and incorporates by reference the entire disclosure of, U.S. Provisional Patent Application No. 60/540,281, filed on Jan. 29, 2004 and bearing Docket No. 57084-01001USPL. This patent application also incorporates by reference the entire disclosure of U.S. Pat. No. 5,487,102.

### BACKGROUND OF THE INVENTION

1. Technical Field

The present invention relates generally to an operator workstation in an operator service center and, more particularly, but not by way of limitation, to an operator workstation having a voice interface board that provides an operator an interface to a public telephone network that controls audio characteristics of audio signals received from and transmitted to a public telephone network from the operator workstation.

2. History of Related Art

An operator service center provides operator services to callers or subscribers. An operator workstation is used by an operator in the operator service center for assisting subscribers connected to a public telephone network to make a call or to answer questions.

The operator workstation must meet several industry-standard criteria as specified in Bellcore's OSSGR Sections 7 and 21 Performance Requirements, Issue 1, February 1991 pertaining to transmit and receive signals to protect the operator using the operator workstation. The criteria specify side tone level, volume level, and limiting.

Side tone is a portion of operator speech that is fed back to a receive path to permit the operator to hear his or her own voice. The operator speech thus fed back is typically attenuated to prevent the operator from lowering his or her own voice and thereby causing insufficient signal levels to be transmitted. Limiting looks for high tones in the receive path and inserts loss to attenuate high tones to protect the operator's hearing. Volume control allows for lowering or increasing of a volume level of incoming audio (e.g., voice) signals. Audio signals from the public telephone network are typically routed to the operator workstation to control the specific characteristics described above. The operator is able to control audio signals that he or she hears via a headset coupled to the operator workstation.

Various prior approaches have implemented controls utilizing analog circuits, which are often difficult and expensive to manufacture and more prone to errors. Analog circuits also often require adjustment of various parameters during manufacture. Thus, the quality of delivered devices might suffer, resulting in loss of customer goodwill.

Other prior approaches have implemented controls utilizing digital circuits to process speech digitally to provide the operator with complete control over echo control, acoustic limiting, side tone control, and volume control. While these approaches may be more reliable than the analog approaches described above, they do not ensure that the operator adjustments of the audio criteria will meet or exceed the Bellcore OSSGR requirements.

In addition to equipping an operator to control the audio characteristics of audio signals, it is also often desirable for an operator workstation to provide an automated mechanism to generate voice messages that can be played back to, for example, subscribers. Such automated voice-message playback may be desirable as more operator service centers rely on automated voice processing to generate greeting and response messages to service caller inquiries. Automated voice features serve to alleviate the need for an operator to vocalize greetings and responses.

It is also frequently desirable to provide access to both an operator and an operator supervisor to incoming calls so that communications with subscribers can be monitored. The operator supervisor can thus roam the operator service center with a headset on and simply plug into an operator workstation to monitor call servicing. Many prior operator workstations that have provided this functionality have been unable to prevent a signal loss from occurring on a connection between the operator and the subscriber when the operator supervisor connects to the operator workstation. The signal loss can result in the operator or subscriber having to repeat themselves, which often reduces the efficiency of the service.

In addition to the above, many operator service centers are migrating or planning to migrate to a voice over IP (VoIP) environment in which packet-switched encoded data connections are employed, as opposed to traditional four-wire-transmission circuit-switched connections. Operator-service-center support for VoIP environments would thus also be desirable.

### SUMMARY OF THE INVENTION

An operator workstation for use by an operator to service subscriber calls, the operator workstation includes a processor, a voice interface circuit, an audio control circuit, and a network interface. The processor is for controlling the operator workstation and decoding and encoding digital data received from the network interface. The voice interface circuit includes a headset interface for transmitting received signals to at least one operator headset and for receiving signals from the at least one operator headset. The audio control circuit is coupled to the voice interface circuit and the processor and is for performing signal mixing for inputs and outputs derived from the voice interface circuit and decoded digital data generated by the processor. The network interface is coupled to the processor and is for transmitting and receiving digital signals with a media gateway.

An operator workstation operable in a plurality of modes for use by an operator to service subscriber calls includes a processor, a voice interface circuit, an audio control circuit, and a network interface. The processor is for controlling the operator workstation and decoding and encoding digital data received from the network interface when the operator workstation is in an encoded-digital-data mode. The voice interface circuit is coupled to a public-telephone-network interface and includes an interface for receiving analog signals from the public-telephone-network interface and transmitting analog signals to the public-telephone-network interface when the operator workstation is in a four-wire-transmission mode and a headset interface for transmitting received signals to at least one operator headset and for receiving signals from the at least one operator headset. The audio control circuit is coupled to the voice interface circuit and the processor and is for adjusting signal characteristics and for recording and generating voice messages in response to operator commands. The network interface is coupled to the processor and is for transmitting and receiving digital signals with a media gateway when the operator workstation is in the encoded-digital-data mode.

### BRIEF DESCRIPTION OF THE DRAWINGS

A more complete understanding of the present invention may be obtained by reference to the following Detailed Description of Exemplary Embodiments of the Invention, when taken in conjunction with the accompanying Drawings, wherein:

FIG. 1 is a block diagram of an operator system for interconnecting an operator workstation in an operator service center with a subscriber station in a four-wire transmission mode;

FIG. 2 is a block diagram of an operator workstation illustrated in FIG. 1;

FIG. 3 is a block diagram of the voice interface board and the audio control board illustrated in FIG. 2;

FIG. 4 is a block diagram of an operator system for interconnecting an operator workstation in an operator service center with a subscriber station in an encoded-digital-data mode;

FIG. 5 is a block diagram of an operator workstation illustrated in FIG. 4; and

FIG. 6 is a block diagram of the voice interface board and the audio control board illustrated in FIG. 5.

### DETAILED DESCRIPTION OF EXEMPLARY EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

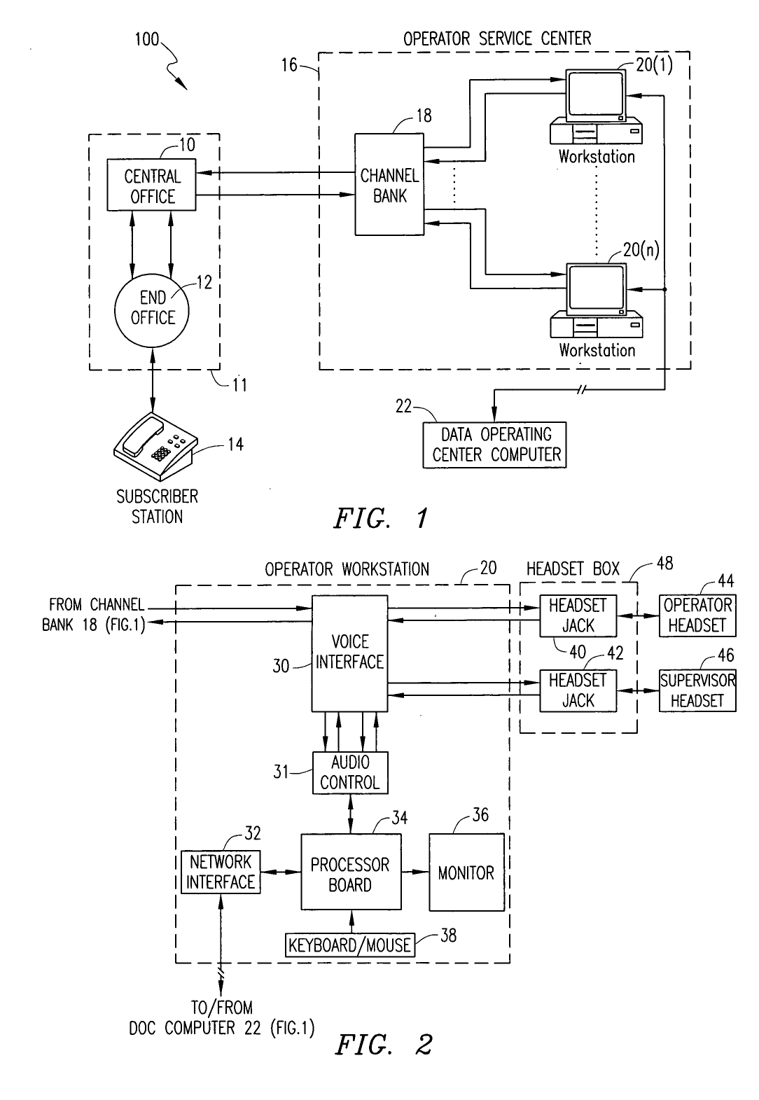

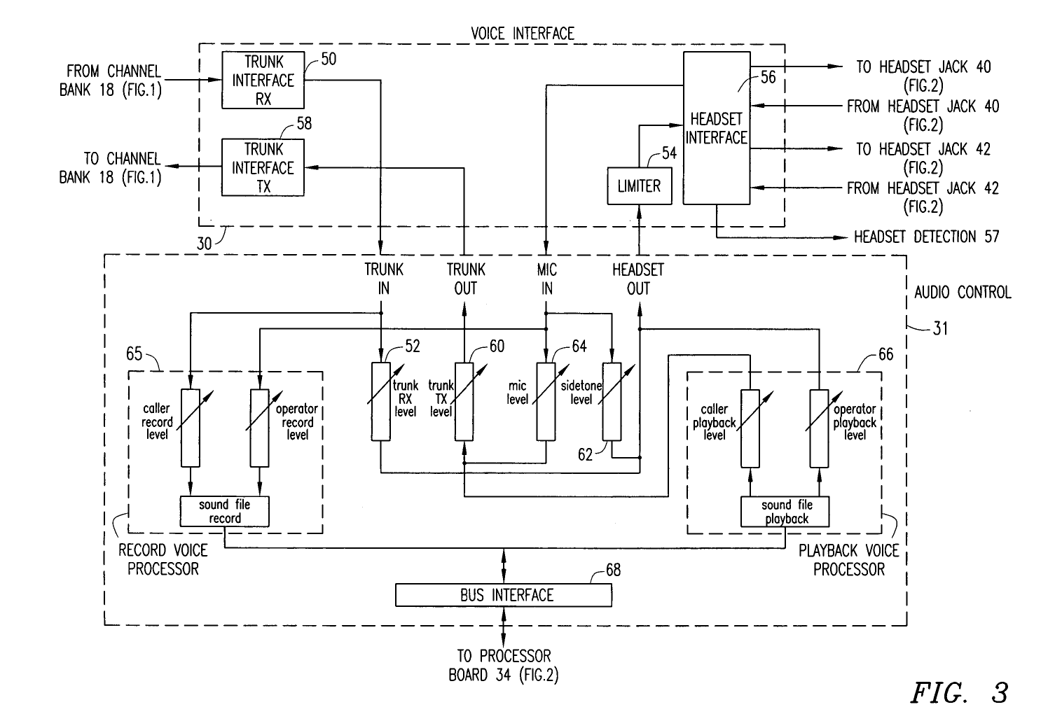

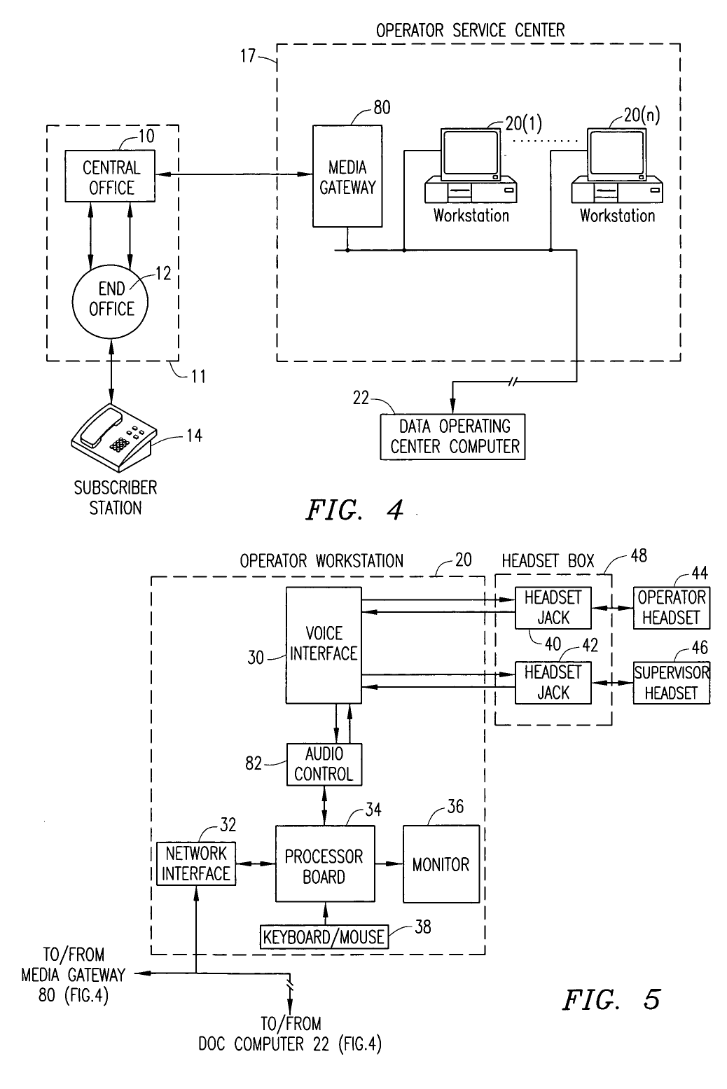

Various embodiments of the invention provide a system for use by an operator of an operator workstation that may be implemented in one of two modes. The first mode is a traditional, circuit-switched, four-wire-transmission mode. The second mode is a packet-switched, encoded-digital-data mode, such as VoIP. FIGS. 1-3 relate to the first mode, while FIGS. 4-6 relate to the second mode.

Referring now to the drawings and initially to FIG. 1, there is illustrated a block diagram of an operator system 100 that illustrates how an operator (not explicitly shown) in an operator service center 16 may be interconnected via a public telephone network 11 to a subscriber station 14 in a four-wire-transmission mode. A configuration as shown in FIG. 1 shows how one or more of a plurality of operator workstations 20(1)-(n) may be configured for use with a four-wire transmission system. As shown, the subscriber station 14 is coupled to an end office 12 of the public telephone network 11. The end office 12 is, in turn, coupled to a central office 10 of the public telephone network 11. The central office 10 is coupled to the operator service center 16 via a T1 carrier link. A T1 carrier is capable of carrying 24 different multiplexed digital signals on a dual, two wire pair, with one pair for transmit and another pair for receive.

The operator service center 16 includes a channel bank 18 coupled to the plurality of operator workstations 20(1)-(n). The channel bank 18 receives multiplexed digital signals, demultiplexes the received signals into 24 separate digital signals, and then converts the demultiplexed digital signals to analog audio signals. The analog audio signals are coupled to the plurality of operator workstations 20(1)-(n). The channel bank 18 also converts analog audio signals received from the plurality of operator workstations 20(1)-(n) to digital, multiplexes the converted signals into a T1 carrier signal, and then transmits the T1 carrier signal to the central office 10.

Each of the plurality of operator workstations 20(1)-(n) may be intercoupled by a local area network (e.g., Ethernet) through a network gateway (not explicitly shown) to a data operating center computer 22. The data operating center computer 22 serves as a data operating center (“DOC”) for the operator service center 16. The DOC computer 22 has associated memory where information such as, for example, telephone directory listings and information to control the plurality of operator workstations 20(1)-(n) may be stored.

FIG. 2 is a functional block diagram of one of the operator workstations 20(1)-(n) of FIG. 1. The operator workstation 20 includes a voice interface board 30, an audio control board 31, a network interface 32, a processor board 34, a monitor 36, and a keyboard/mouse 38. The audio control board 31 may be, for example, a personal computer sound card. Headset jacks 40 and 42 in a headset box 48, which headset jacks 40 and 42 are not part of the operator workstation 20, are also shown to illustrate an interface when an operator and/or supervisor plugs into the workstation 20. The monitor 36 and the keyboard/mouse 38 provide the operator with an input/output interface to the operator workstation 20. The processor board 34, which is coupled to the monitor 36, the keyboard/mouse 38, the network interface 32, and the audio control board 31, sends and receives information from an operator interface (i.e., the monitor 36 and the keyboard/mouse 38) and the DOC computer 22 (See FIG. 1) through the network interface 32. The processor board 34 generates signals in response to signals received from the operator interface and the DOC computer 22 (See FIG. 1) to control the operation of the audio control board 31.

The voice interface board 30 intercouples audio signals from the channel bank 18 (See FIG. 1) to an operator headset 44, and, if appropriate, to a supervisor headset 46. The voice interface board 30 conditions and controls the audio characteristics of the audio signals transmitted between the channel bank 18 and the operator headset 44 and/or the supervisor headset 46.

The audio control board 31 provides signal mixing for all inputs and outputs derived from the voice interface board 30 and any additional audio signals that are generated by software from the processor board 34. The audio control board 31 also provides level control for recording and playback of voice files stored on the operator workstation 20. The resulting audio signals are passed via the appropriate connectors to the voice interface board 30, which signals in turn are presented to the operator headset 44 and if appropriate, to the supervisor headset 46.

FIG. 3 is a functional block diagram of the voice interface board 30 and the audio control board 31 of FIG. 2. The voice interface board 30 includes a trunk interface RX 50, a limiter circuit 54, a headset interface 56, and a trunk interface TX 58. Incorporated within the headset interface 56 is a headset detection circuit 57 that signals the operator workstation 20 when a headset is connected to either of the headset jacks 40 and 42.

The audio control board 31 (See FIG. 2) provides controls for setting appropriate signal levels for audio received and transmitted by the voice interface board 30 and from sound files played or recorded through the processor board 34. The provided controls may include a trunk transmit level control 60, a side tone level control 62, an operator microphone level control 64, a playback voice processor 66, and a record voice processor 65. Settings of the level controls present on the audio control board 31 (See FIG. 2) are controlled via a bus interface 68 and are set via software running on the operator workstation 20. The bus interface 68 may be, for example, a 32-bit PCI-compatible bus interface. A user of the operator workstation 20 may modify, within a controlled range, the level settings for one or more of a trunk receive level control 52, a microphone level control 64, and a side tone level control 62. The remaining level controls are typically preset by software running on the processor board 34 to ensure that all transmit and receive levels are optimally set and are compliant with signal levels required for use with the relevant public telephone network (e.g., the public telephone network 11).

When operated in the four-wire-transmission mode, the voice interface board 30 can be divided into a receive path and a transmit path. The receive path includes the trunk interface RX 50. In operation, the trunk interface RX 50 receives an audio signal from the channel bank 18 (See FIG. 1). The resulting audio is then passed directly to the audio control board 31, which provides the trunk RX level control 52. The adjusted audio provided by the audio control board 31 is then returned to the voice interface board 30 and passed to the limiter circuit 54 and the headset interface 56. The limiter circuit 54 ensures that the audio signal presented to both of the headset jacks 40 and 42 does not exceed defined sound levels that comply with health and safety regulations for continual usage and acoustic shock.

The audio control board 31 also provides a control for side tone, in which a portion of the audio (e.g., voice) signal from the operator and supervisor is returned back to their headsets. The amount of side tone returned is adjusted by the side tone level control 62, which is then passed to the limiter circuit 54 and the headset interface 56.

The playback voice processor 66 provides playback of stored voice files or audio signals generated on the operator workstation 20. Audio signals that originate from the playback voice processor 66 are controlled by the processor board 34 (See FIG. 2) via the bus interface 68. The playback voice processor 66 may be adapted to play a voice file and present the voice to the subscriber station 14 (See FIG. 1) via the channel bank 18 and to a participating operator via the headset interface 56 using individual signal level controls. The played-back voice file may be mixed with, for example, the voice signal from the trunk interface RX 50.

The record voice processor 65 provides recording of, for example, voice files, which may be stored for later retrieval. The record voice processor 65 is controlled by the processor board 34 (See FIG. 2) via the bus interface 68. The record voice processor 65 may record a voice file and store that voice file for later use. The record voice processor 65 may be adapted to record voice that originates from the subscriber station 14 (See FIG. 1) via the channel bank 18 and from the participating operator via the headset interface 56 using individual signal level controls.

The trunk interface RX 50 provides a four-wire E&M telephone trunk circuit that interfaces to the channel bank 18 to receive audio signals. The trunk interface RX 50 matches the impedance of the channel bank 18 with that of the voice interface board 30 and electrically isolates the telephone trunk circuit from the remainder of the voice interface board 30. The trunk receive level control 52 conditions the received audio signal to adjust the voltage level of the received audio signal. The bus interface 68 may control operation of the volume level of the receive signal via software running on the processor board 34.

The headset interface 56 matches the impedance of the voice interface board 30 to the operator headset 44 and the supervisor headset 46 microphone and earpiece. Signals from the operator microphone and the supervisor microphone are conditioned by the microphone level control 64. The side tone level control 62 supplies a portion of the microphone signal to the limiter circuit 54. The limiter circuit 54 drives the resulting signal out to both the operator headset 44 and the supervisor headset 46. The headset interface 56 effectively isolates the signals transmitted to the operator headset 44 and the supervisor headset 46 so that connection or disconnection of one of the operator headset 44 or the supervisor headset 46 will not affect the audio signal being transmitted to the other headset or to the subscriber station 14 (See FIG. 1). The isolation is accomplished by separately driving each headset connection, so that a signal received or sent from, for example, a first headset 44 is not altered by inserting or removing a second headset.

Reference is now made to FIG. 4, where there is illustrated a block diagram of an operator system that shows how an operator in an operator service center may be interconnected via a public telephone network to a subscriber station in an encoded-digital-data mode. The operator workstation 20 may be configured in the encoded-digital-data mode for use with a digitally-encoded audio signal, which signal may be transmitted over a local area network. As shown, the subscriber station 14 is coupled to the end office 12, which, in turn, is coupled to a central office 10. The central office 10 and the end office 12 are part of the public telephone network 11. The central office 10 is coupled to the operator service center 17 via a T1 carrier link.

The operator service center 17 includes a media gateway 80 coupled to the plurality of operator workstations 20(1)-(n) over a local area network. The media gateway 80 receives multiplexed digital signals and converts the received multiplexed digital signals to encoded digital data. The encoded digital data are transmitted over the local area network to the operator workstations 20(1)-(n), which receive the encoded digital data. The operator workstations 20(1)-(n) also encode audio signals and transmits the encoded audio signals over the local area network to the media gateway 80. The received encoded audio signals are directed back to the subscriber station 14 by the media gateway 80.

Each one of the plurality of operator workstations 20(1)-(n) is also inter-operably coupled by the local area network (e.g., Ethernet) through a network gateway (not explicitly shown) to the DOC computer 22. The DOC computer 22 serves as a data operating center for the operator service center 17. The DOC computer 22 has associated memory where information such as telephone directory listings and information to control the plurality of operator workstations 20(1)-(n) may be stored.

A functional block diagram of one of the operator workstations 20(1)-(n) of FIG. 4 is illustrated in FIG. 5. The operator workstation 20 includes the voice interface board 30, an audio control board 82, the network interface 32, the processor board 34, the monitor 36, and the keyboard/mouse 38. The audio control board 82 is structurally identical to the audio control board 31; however, software controlling the audio control board 82 differs from that of the audio control board 31, as described in more detail below. The audio control board 31 may be, for example, a personal computer sound card. As will be apparent to those having skill in the relevant art, various embodiments of an operator workstation may be adapted to operate in either of a four-wire-transmission mode and an encoded-digital-data mode responsive to a selection by a operator-service-center administrator or other user.

The headset jacks 40 and 42 in the headset box 48, which are not part of the operator workstation 20, are also shown to illustrate the interface where an operator or supervisor plugs into the operator workstation 20. The monitor 36 and keyboard/mouse 38 provide the operator with an input/output interface to the operator workstation 20. The processor board 34 coupled to the monitor 36, the keyboard/mouse 38, the network interface 32, and the audio control board 82, sends and receives information from the operator interface (i.e., the monitor 36 and the keyboard/mouse 38) and the DOC computer 22 (See FIG. 4) via the network interface 32. The processor board 34 generates signals in response to signals received from the operator interface and the DOC computer 22 (See FIG. 4) to control operation of the audio control board 82.

The network interface 32 provides a path to the operator workstation 20 for the encoded digital data from the media gateway 80. The network interface 32 is typically connected to the same local area network as the DOC computer 22 (See FIG. 4). Software running on the processor board 34 may be adapted to decode the encoded digital data from the media gateway 80 and present the decoded audio data to the audio control board 82. The audio control board 82 controls and conditions the received decoded audio data and presents resulting audio to the voice interface board 30 and ultimately to the operator headset 44 and the supervisor headset 46.

The audio control board 82 provides signal mixing for all inputs and outputs derived from the voice interface board 30 along with decoded audio data generated by software from the processor board 34. Configuration of the audio control board 82 is defined by software running on the processor board 34 and is specifically configured for operation using encoded digital data. The audio control board 82 provides level control for recording and playback of previously-stored voice files. The resulting audio signals are passed via appropriate connectors to the voice interface board 30. The voice interface board 30 presents the audio signals to the operator headset 44 and, if appropriate, to the supervisor headset 46.

For audio generated at the operator workstation 20, software running on the processor board 34 encodes the resulting audio signal and transmits encoded digital data via the local area network to the media gateway 80 (See FIG. 4). Audio signals received from the operator headset 44 and the supervisor headset 46 are received on the voice interface board 30. The received audio signals are passed by the voice interface board 30 to the audio control board 82. The audio control board 82 controls and conditions the received audio signals. Software running on the processor board 34 samples and encodes the received audio signals using a process that is compatible with the media gateway 80 (See FIG. 4). The network interface 32 transmits encoded digital data from the processor 34 to the media gateway 80 (See FIG. 4).

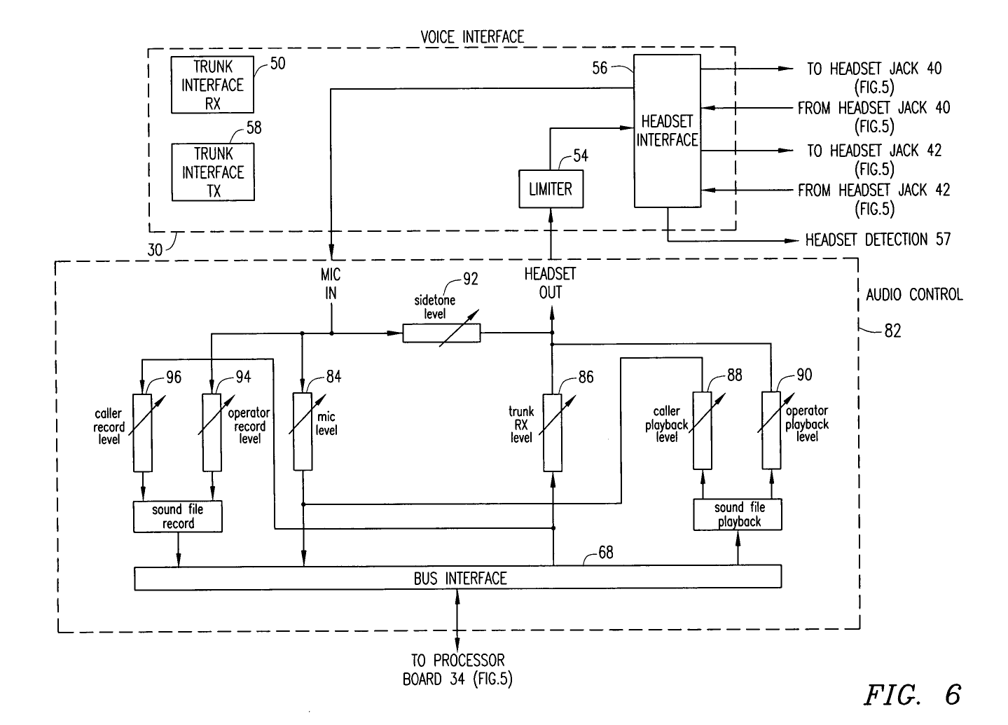

FIG. 6 is a functional block diagram of the voice interface board 30 and the audio control board 82 illustrated in FIG. 5, configured for use with encoded digital data. The voice interface board 30 utilizes the headset interface 56 and the limiter circuit 54. Various hardware modules on the voice interface board 30, which are used to support a four-wire E&M signaling trunk interface, are not required for the encoded-digital-data mode of operation and therefore are not indicated in FIG. 6 to be connected. Incorporated within the headset interface 56 is the headset detection circuit 57, which signals the operator workstation 20 when a headset is connected to either of the headset jacks 40 or 42.

The audio control board 82 provides controls used to set appropriate signal levels for audio received and transmitted by the voice interface board 30 and from encoded digital data from the media gateway 80. The audio control board 82 also provides control of sound files played or recorded through the processor board 34, including microphone level control 84, side tone control 92, trunk receive level control 86 [is this correct in this mode.?], operator playback level control 90, caller playback level control 88, operator record level control 94, and caller record level control 96. Settings of the level controls present on the audio control board 82 are controlled via the bus interface 68 and are set by software running on the operator workstation 20.

A user of the operator workstation 20 may modify, within a controlled range, the level settings for the trunk receive level control 86, the microphone level control 84, and the side tone level control 92. The remaining level controls are preset by the software running on the processor board 34 to ensure that all transmit and receive levels are optimally set and are compliant with signal levels required for use with the relevant public telephone network. Additional level controls may also be configured to provide supplemental signal conditioning, but have been omitted from FIG. 6 for the sake of clarity.

When operating in the encoded-digital-data mode, the voice interface board 30 may be divided into a receive path and a transmit path. In operation, the encoded digital data is received by the operator workstation 20 from the media gateway 80. The processor board 34 decodes the encoded digital data and presents the resulting audio to the audio control board 82. The trunk receive level control 86 provides adjustment of the incoming audio signal. The audio signal is passed to the voice interface board 30, through the limiter circuit 54, and into the headset interface 56. The limiter circuit 54 ensures that the audio signal presented to both the operator headset jack 40 and the supervisor headset jack 42 does not exceed defined sound levels that comply with heath and safety regulations for continual usage and acoustic shock.

The transmit path includes the headset interface 56. Operator and supervisor audio is passed by the voice interface board 30 directly to the audio control board 82. The audio control board 82 provides the microphone level control 84. The resulting audio from the audio control board 82 is sampled via software running on the processor board 34 and is encoded via process compatible with the media gateway 80. The audio control board 82 also provides a control for side tone. The amount of side tone returned is adjusted by the side tone level control 92, which audio is then passed to the limiter circuit 54 and to the headset interface 56.

Playback of stored voice files or other audio generated on the operator workstation 20 is controlled by software running on the processor board 34. The resulting audio is then made available to the caller and operator by adjusting the level controls 88 and 90. Recording of audio from both the caller and operator is provided by software running on the processor board 34. Adjustment of the signal levels to be recorded is provided by the level controls 94 and 96. Recorded voice or other audio files may be stored for later use. As noted above, the bus interface 68 may be, for example, a 32-bit PCI-compatible bus interface.

The headset interface 56 matches the impedance of the voice interface board 30 to the microphone and the earpiece of the operator headset 44 and the supervisor headset 46. The signals from the operator microphone and the supervisor microphone are conditioned by the microphone level control 64. The side tone level control 62 supplies a portion of the microphone signal to the limiter circuit 54, which drives the resulting signal out to both the operator headset 44 and the supervisor headset 46. The headset interface 56 effectively isolates the signals transmitted to the operator headset 44 and the supervisor headset 46 so that the connection or disconnection of one of the operator headset 44 or the supervisor headset 46 will not affect the audio signal being transmitted to the other headset or to the subscriber station 14 (See FIG. 4). The isolation is accomplished by separately driving each headset connection so that a signal received or sent from, for example, a first headset is not altered by inserting or removing a second headset.

In operation, an operator using the operator workstation 20 logs on to the DOC computer 22. Stored on the DOC computer 22 is an operator profile for each operator working in the operator service center 17. The operator profile contains parameters downloaded through the network to the operator workstation 20 to control the audio characteristics of audio signals received by and transmitted from the operator workstation 20. The operator profile allows for the customization of each of the operator workstations 20(1)-(n) for the current operator who is working on one of the operator workstations 20(1)-(n).

The parameters stored on the DOC computer 22 are used to control, for example, (1) the volume level of the audio signal received by the operator, (2) the volume level of the audio signal transmitted by the operator to the subscriber station 14, (3) side tone. The parameters also configure the operator workstation 20 to work in either four-wire transmission mode or encoded-digital-data mode. The parameters are typically downloaded to the operator workstation 20 from the DOC computer 22 through the gateway (not explicitly shown).

Initially, default parameters are used based on system requirements. For example, a customer can specify default parameter values by requesting that the parameters be set to satisfy Bellcore's OSSGR requirements for an operator workstation. However, as explained in more detail below, the operator can control the receive volume level on a per-call basis. The parameters downloaded from the DOC computer 22 are received by the processor board 34 and are then passed by the processor board 34 through the bus interface 68 to the audio control board 31/82.

The audio characteristics parameters stored in the DOC computer 22 are typically controlled by a system administrator through an administrator workstation (not shown) coupled to the DOC computer 22. The administrator can provide the same profile for all operators or individual profiles can be developed to meet the individual needs of each operator.

Audio characteristics that may be controlled by the operator are, for example, receive, transmit, and side tone volume level. The operator may, for example, control the receive or transmit level by depressing one of two dedicated keys (e.g., volume-up key and volume-down key) on the keyboard/mouse 38 to indicate that the level should be increased or decreased. By depressing the keys, the operator causes the keyboard/mouse 38 to adjust the level setting of the appropriate level control. The adjustments that can be made by the operator are typically limited to a range that sets the maximum and minimum level settings.

In various embodiments of the invention, the operator may adjust the volume for each call. After a call is completed, the processor board 34 may reconfigure one or more of the receive level control, transmit level control, and side tone level control to default volume levels, since each call is typically from a different person calling from a different location resulting in different characteristics for the audio signals. Note that if the received audio signal is too loud, the limiter circuit 54 may automatically reduce the volume to a predetermined level.

It should be emphasized that the terms “comprise”, “comprises”, and “comprising”, when used herein, are taken to specify the presence of stated features, integers, steps, or components, but do not preclude the presence or addition of one or more other features, integers, steps, components or groups thereof. The previous Detailed Description is of embodiment(s) of the invention. The scope of the invention should not necessarily be limited by this Description. The scope of the invention is instead defined by the following claims and the equivalents thereof.

1. An operator workstation for use by an operator to service subscriber calls, the operator workstation comprising:
a processor for:
controlling the operator workstation; and
decoding and encoding digital data received from a network interface;
a voice interface circuit comprising a headset interface for transmitting received signals to at least one operator headset and for receiving signals from the at least one operator headset;
an audio control circuit coupled to the voice interface circuit and the processor for performing signal mixing for inputs and outputs derived from the voice interface circuit and decoded digital data generated by the processor; and
a network interface coupled to the processor for transmitting and receiving digital signals with a media gateway.

2. The operator workstation of claim 1, wherein:
configuration of the audio control circuit is defined by software running on the processor; and
the audio control circuit is configured for operation using digital data.

3. The operator workstation of claim 1, wherein the audio control circuit is adapted to provide level control for recording and playback of previously-stored voice files.

4. The operator workstation of claim 3, wherein:
the audio control circuit is adapted to output audio signals to the voice interface circuit; and
the voice interface circuit is adapted to present the output audio signals to an operator headset.

5. The operator workstation of claim 4, wherein the processor is adapted to encode operator audio signals and transmits resulting encoded digital data via a the network interface to the media gateway.

6. The operator workstation of claim 1, wherein the audio control board is adapted to condition received audio signals and transmit the conditioned audio signals to the processor for sampling and encoding.

7. The operator workstation of claim 1, wherein the audio control board is adapted to provide controls used to set appropriate signal levels for audio received and transmitted by the voice interface circuit and from encoded digital data from the media gateway.

8. The operator workstation of claim 1, wherein the audio control board is adapted to provide control of sound files played and recorded via the processor.

9. The operator workstation of claim 8, wherein the sound files comprise at least one of a microphone level control, a side tone control, operator playback level control, caller playback level control, operator record level control, and caller record level control.

10. The operator workstation of claim 1, wherein the operator workstation is adapted to receive downloaded operator-specific parameters to control audio characteristics of audio signals received by and transmitted from the operator workstation.

11. The operator workstation of claim 1, wherein the operator workstation is adapted to download parameters used to control at least one of a volume level of audio signals received by the operator, a volume level of audio signals transmitted by the operator to a subscriber station, and a side tone level.

12. The operator workstation of claim 11, wherein the parameters also comprise a parameter to configure the operator workstation to operate in either a four-wire transmission mode or an encoded-digital-data mode.

13. An operator workstation operable in a plurality of modes for use by an operator to service subscriber calls, the operator workstation comprising:
a processor for:
controlling the operator workstation; and
decoding and encoding digital data received from a network interface when the operator workstation is in an encoded-digital-data mode;
a voice interface circuit coupled to a public-telephone-network interface, the voice interface circuit comprising:
an interface for receiving analog signals from the public-telephone-network interface and transmitting analog signals to the public-telephone-network interface when the operator workstation is in a four-wire-transmission mode; and
a headset interface for transmitting received signals to at least one operator headset and for receiving signals from the at least one operator headset;
an audio control circuit coupled to the voice interface circuit and the processor for adjusting signal characteristics and for recording and generating voice messages in response to operator commands; and
a network interface coupled to the processor for transmitting and receiving digital signals with a media gateway when the operator workstation is in the encoded-digital-data mode.

14. The operator workstation of claim 13, wherein the voice interface circuit further comprises a microphone interface coupled to the headset interface and a microphone interface of the audio control circuit for transmitting audio signals from the operator.

15. The operator workstation of claim 13, wherein:
the interface of the voice interface circuit comprises:
a trunk-interface-receive interface; and
a trunk-interface-transmit interface; and
the audio control circuit comprises:
a trunk-in interface coupled to the trunk-interface-receive interface;
a trunk-out interface coupled to the trunk-interface-transmit interface;
a microphone-in interface;
a bus interface; and
a headset-out interface.

16. The operator workstation of claim 15, wherein the trunk-interface-receive interface and the trunk-interface-transmit interface are not used when the operator workstation is in the encoded-digital-data mode.

17. The operator workstation of claim 13, wherein the audio control circuit comprises a personal-computer sound card.

18. The operator workstation of claim 13, wherein a personal-computer sound card comprises the audio control circuit.
